(19) United States
(12) Patent Application Publication
(10) Pub. No.: US 2010/0096151 A1
(43) Pub. Date: Apr. 22, 2010

(54) PORTABLE POWER TOOL WITH WIRELESS COMMUNICATION WITH A STATIONARY CONTROL UNIT

(75) Inventor: Carl Gunnar Östling, Nacka (SE)

Correspondence Address: FRISHAUF, HOLTZ, GOODMAN & CHICK, PC, 220 Fifth Avenue, 16TH Floor, NEW YORK, NY, 10001-7708, US

(73) Assignee: Atlas COPCO Tools AB, Nacka (SE)

(21) Appl. No.: 12/523,144

(22) PCT Filed: Jan. 14, 2008
(86) PCT No.: PCT/SE2008/000021

§ 371 Date: Jul. 14, 2009

(30) Foreign Application Priority Data
Jan. 15, 2007 (SE) 0700064-9

(51) Int. Cl. B25B 21/00; B25B 23/00

(52) U.S. Cl. 173/2

(57) ABSTRACT

A portable power tool, wirelessly communicates with a stationary process control unit for exchange of operation parameter values, includes a housing with a battery powered motor connected to an output shaft, an on-board operation controller, and a wireless communication device in the form of a communication module. The communication module is received in a docking portion on the housing, and the docking portion and the communication module have matching electrical connectors. The communication module is one of a number of exchangeable communication modules all having identical electrical connectors for co-operation with the connection of the docking portion but which include communication devices for wireless communication according to different communication systems.

The invention relates to a portable power tool for performing working operations according to certain operation parameter values, wherein desired parameter values and obtained working operation results are communicated between the power tool and a stationary process control unit via a wireless communication system.

Power tools of this type, mainly battery powered power wrenches with no cable connection with the process control unit, have a growing application in assembly line operations, for instance in assembling of automobile bodies and the like. This type of tools has become increasingly more advanced with on-board operation control means and wireless transmission of operation data between the on-board operation control means and a stationary process control unit. This communication is performed via different wireless systems, like W-lan, Bluetooth etc. according to what particular system is preferred by the actual operator.

A problem concerned with this type of power tool is that the tools produced today are specifically designed to operate according to one specific communication system, and if a tool has to be adapted to another communication system there is required a difficult and time consuming operation to redesign the tool, i.e. changing the transmitting/receiving means according to one system originally fitted to the power tool to another transmitting/receiving means. That operation normally requires a certain amount of work for dismantling and reassembling the power tool to get access to and remove the transmitting/receiving means and to enable fitting of an alternative equipment. This is a tricky and time consuming operation which causes undesired extra costs to the operator.

An alternative way to change communication system is to exchange the entire power tool for another tool provided with the desired communication system. This also means an increased cost, because the power tool supplier has to specifically design a number of power tool models with different communication systems, which adds to the costs for keeping an increased number of tools in stock.

The present invention provides a power tool adaptable for wireless communication with a stationary process control unit in accordance with different communication systems in that the wireless transmitting/receiving means on-board the power tool is easily and readily exchanged for a transmitting/receiving means operating in accordance with an alternative communication system.

Further characteristic features and advantages of the invention will appear from the following specification and claims.

A preferred embodiment of the invention is below described in detail with reference to the accompanying drawing.

In the drawing

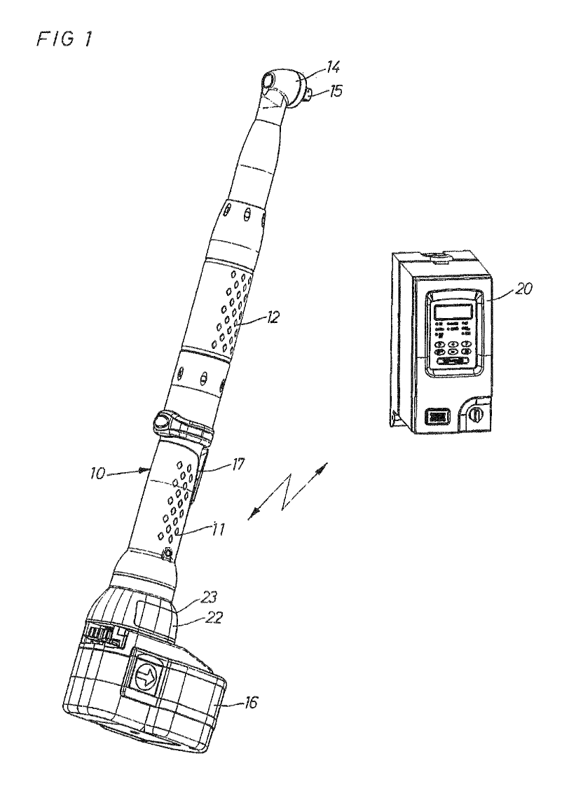

FIG. 1 shows a perspective view of a power tool according to the invention.

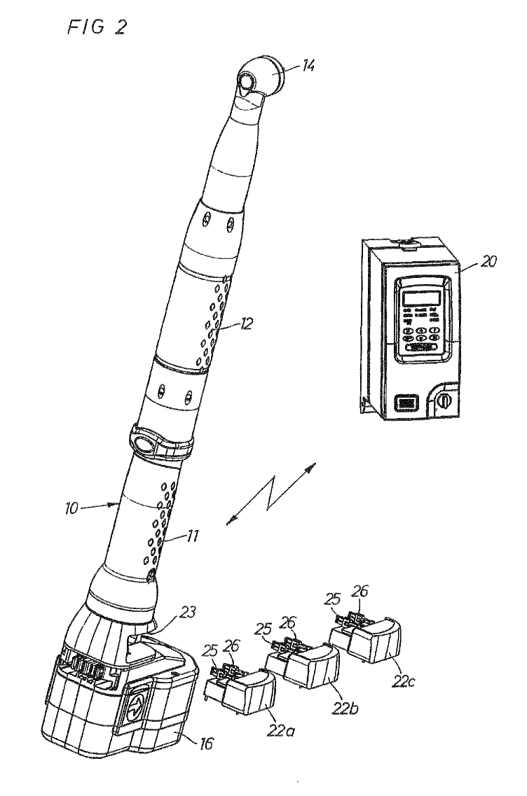

FIG. 2 shows a perspective view of the power tool in FIG. 1 illustrating alternative separate communication modules.

The power tool illustrated in the drawings is a battery powered angle nutrunner which comprises a housing 10 formed with external grip sections 11, 12 for manual support of the tool during work operations. At its forward end the housing 10 is provided with an angle head 14 with an output shaft 15, and at its rear end the housing 10 carries an exchangeable and rechargeable battery unit 16. Inside the housing 10 there is supported an electric motor which is drivingly connected to the output shaft 15, and a key 17 is provided on the housing 10 for the operator to initiate the power supply to the motor.

The power tool also comprises an on-board operation control means (not illustrated) for controlling the operation of the motor in accordance with certain parameter values, like target torque level, and a wireless communication system is arranged to communicate operation data between the power tool and a stationary control unit 20. This communication system comprises a transmitter/receiver on-board the power tool and a transmitter/receiver in the stationary control unit 20, both operating according to the same communication system, for instance Bluetooth, W-lan etc. The results of each performed screw joint tightening processe, like the actually obtained torque level, the lapsed rotation angle of the output shaft during the final tightening, and other data like for instance the remaining battery capacity, motor temperature etc. are communicated back to the control unit 20, whereas power tool operation data as tightening parameter values to be used during tightening of a certain screw joint are communicated from the control unit 20 to the power tool.

The communication means comprising a transmitter/receiver on-board the power tool has the form of a separate communication module 22 which is connected to the tool via a docking portion 23 on the housing 10. The latter has the form of a pocket in which the main part of the communication module 22 is received, and the communication module 22 and the docking portion 23 comprise matching connection means 25,26 for electrically connect the communication module 22 to the on-board operation control means as the communication module 22 is docked to the power tool. The connection means 25,26 on the communication module 22 comprises a pair of rigidly attached connector elements.

The communication module 22 is one of a number of interchangeable communication modules 22a-c all comprising means for wireless communication according to different communication systems, like Bluetooth, W-lan etc. This means that one power tool can easily be adapted to different communication systems, just by exchanging communication module. No dismantling/reassembly work is needed, and the number of power tool models kept available to the customers could be minimized. It is crucial though that the alternative communication modules 22a-c comprise identical connection means 25,26 for co-operation with the connection means of the docking portion 23.

It is to be considered that the embodiments of the invention are not limited to the illustrated and described example but may be freely varied within the scope of the claims. Accordingly, the docking portion 23 on the power tool housing 10 may have other forms than a pocket, and the connection means between the communication module 22 and the docking portion 23 may have different forms, like male/female plug/jack type or sheet metal contact strips.

1. A portable power tool which wirelessly communicates with a stationary process control unit, comprising:
a housing,
a motor,
an on-board operation controller, and
a wireless communication device which communicates tool operation data between the on-board controller and the stationary process control unit, wherein:
the on-board wireless communication device is formed as a separate communication module, and a docking portion is formed on the housing for receiving and firmly retaining said communication module, said docking portion and said communication module have matching electric connection devices to be interengaged as said communication module is received by said docking portion, thereby connecting said communication module with the on-board operation controller.

2. A power tool according to claim 1, wherein said separate communication module is one of a number of interchangeable communication modules all having identical connection devices but comprising communication devices for operation according to different wireless communication systems.

3. A power tool according to claim 1, wherein said docking portion is formed as a pocket for receiving at least partly said communication module, and said pocket is provided with said connection device for engaging said connection device on said communication module.

4. A power tool according to claim 1, wherein said connection device on said communication module comprises a pair of rigidly attached connector elements.

5. A power tool according to claim 2, wherein said docking portion is formed as a pocket for receiving at least partly said communication module, and said pocket is provided with said connection device for engaging said connection device on said communication module.

6. A power tool according to claim 5, wherein said connection device on said communication module comprises a pair of rigidly attached connector elements.

7. A power tool according to claim 2, wherein said connection device on said communication module comprises a pair of rigidly attached connector elements.

8. A power tool according to claim 3, wherein said connection device on said communication module comprises a pair of rigidly attached connector elements.
